(19) United States
(12) Patent Application Publication
(10) Pub. No.: US 2014/0309156 A1
(43) Pub. Date: Oct. 16, 2014

(54) APE Free Cleaning Composition with Reduced VOC

(71) Applicant: Dow Global Technologies LLC, Midland, MI (US)

(72) Inventors: Cynthia L. Rand, Sanford, MI (US); Molly I. Busby, Midland, MI (US); Lisa B. Quencer, Midland, MI (US); Flor A. Castillo, Lake Jackson, TX (US)

(21) Appl. No.: 14/359,204

(22) PCT Filed: Nov. 19, 2012
(86) PCT No.: PCT/US2012/065824

§ 371 Date: May 19, 2014

Related U.S. Application Data
(60) Provisional application No. 61/565,703, filed on Dec. 1, 2011.

(51) Int. Cl. C11D 1/72; C11D 3/20

(52) U.S. Cl. CPC C11D 1/72; C11D 3/2068
USPC 510/506

(57) ABSTRACT

The present disclosure provides a composition comprising at least one primary branched nonionic surfactant of Formula (I) wherein x is an integer from 1 to 11, y is an integer from 0 to 25, R₁ is an alkyl group having 1 to 5 carbon atoms, and R₂ is an alkyl group having 3 to 7 carbon atoms; and a secondary alcohol ethoxylate of Formula (II): wherein R₃ and R₄ are linear alkyl groups each having from 1 to 12 carbon atoms, and n is an integer from 1 to 20.

### FIELD OF THE INVENTION

This invention relates to a composition comprising a nonionic surfactant and a secondary alcohol ethoxylate.

### INTRODUCTION

One of the most important classes of industrial chemicals are surfactants or surface active agents, and especially, nonionic surfactants, that are used in a vast array of industrial and consumer applications such as the preparation of cleaning products, agricultural products, adhesives, pharmaceuticals, cosmetics, textiles, or specialty surface coatings for metals, glasses, and plastics, to name a few. Typically the surfactant or a blend of surfactants is only a small component of a complex formulation that is specifically designed to provide the required performance attributes for the given application. Although formulations and components may vary for each application, the stability of the formulated product is a general requirement that is critical in any industrial or consumer product. Stability usually means that the formulation remains constant in its composition and physical form over a range of temperatures and conditions while providing the same performance, visible or measurable, each time the formulation is prepared, transported, stored, or used over time. Generally this type of formulation work will require considerable experimentation to develop the most cost effective formulations with best performance attributes possible. To simplify this procedure, formulation scientists will also be interested in developing stable base formulations in which to test the effects of secondary additives that are often added to customize or refine the formulations such as perfumes, pigments, thickening agents and dispersants, etc., while monitoring the stability of the fully formulated products.

The stability and temperature range of use of the compositions is also of significant importance to the producer of the components and the formulator of the components. The producer must ensure that their product is stable to manufacturing conditions, transfer operations, shipping and storage. The need to remix, heat or cool a component will always add manufacturing complexity and cost to a product.

Surfactants in many formulated products are distinguished by their rate of biodegradation, degradation products, and level of aquatic toxicity. The Design for the Environment (DfE) Criteria for Surfactants and other similar certification programs combine these hazard characteristics, and require that surfactants with higher aquatic toxicity demonstrate a faster rate of biodegradation without degradation to products of concern. Surfactants that meet the Criteria are acceptable for use in a DfE-labeled cleaning product

There exists a need to create new DfE compliant surfactants and formulations, which are alkyl phenol ethoxylate (APE)-free and have reduced volatile organic compounds (VOC). The drive for new formulated products to meet the certified label has further highlighted the need for a stable surfactant formulation that can serve as an effective alternative to the broadly used APE surfactants. The invention of such a base surfactant formulation would greatly simplify reformulation efforts for brand owners. A critical attribute of such an invention, independent of application, requires the formulation to be in a liquid form that exhibits an acceptable viscosity profile to enable easy transfer of the concentrate demonstrated by a lack of gel formation or phase separation under transport or use conditions. Additionally, such an invention requires a temperature stability such that the concentrate remains a clear, flowing liquid under long term stability tests.

When focused on hard surface cleaning as a specific application, additional critical performance attributes of the surfactant formulation would include good cleaning and degreasing capabilities, minimal visual residue in the form of filming/streaking, and flexible incorporation of formulation additives such as chelants, solvents, perfumes and dyes without loss of cleaning performance. A successful formulation would also demonstrate filming and streaking performance that is comparable to or better than conventional alkyl polyglucoside containing formulations and APE containing formulations. Further attributes of a successful formulation would include 0.5% or less volatile organic compounds while providing temperature stability up to 60° C. Currently there are no surfactant formulations that can meet both of these industry performance standards while still providing stable base formulations that are easily customized.

### SUMMARY

The present disclosure is directed to a composition which has excellent stability both as a concentrate and when used in a fully formulated product. The composition delivers visual attributes of filming/streaking that are comparable to the industry gold standard associated with alkyl polyglucoside-based formulations; however, the composition retains an excellent cleaning performance typically seen with non-ionic surfactants. In addition, the composition is able to couple hard to disperse additives such as fragrances into aqueous cleaner formulations while maintaining temperature stability, which is something for which alkyl polyglucosides are not well suited.

In an embodiment, the composition comprises (A) at least one primary branched nonionic surfactant of Formula (I) wherein x is an integer from 1 to 11, y is an integer from 0 to 25, R₁ is an alkyl group having 1 to 5 carbon atoms, and R₂ is an alkyl group having 3 to 7 carbon atoms;

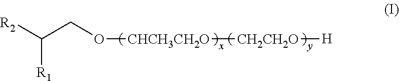

and
b) a secondary alcohol ethoxylate of Formula (II)

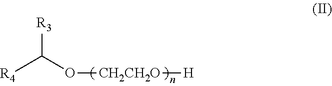

wherein R₃ and R₄ are linear alkyl groups each having from 1 to 12 carbon atoms, and n is an integer from 1 to 20.

### BRIEF DESCRIPTION OF THE DRAWINGS

FIG. 1 is a ternary diagram.

### DETAILED DESCRIPTION

### Definitions

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, etc., is from 100 to 1,000, then all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure.

### Composition

The present disclosure provides a surfactant composition comprising a primary branched nonionic surfactant and a secondary alcohol ethoxylate.

### Primary Branched Nonionic Surfactant

The composition of the present disclosure includes at least one primary branched nonionic surfactant of Formula (I)

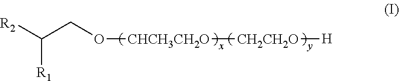

wherein x is an integer from 1 to 11, y is an integer from 0 to 25, R₁ is an alkyl group having 1 to 5 carbon atoms (i.e., C₁-C₅), and R₂ is an alkyl group having 3 to 7 carbon atoms (C₃-C₇). Preferably x is from 4 to 6, more preferably x is 5. Preferably y is from 1 to 20, more preferably y is 6 or 9. Preferably R₁ is ethyl (C₂) or propyl (C₃). Preferably R₂ is butyl (C₄) or pentyl (C₅).

In an embodiment, the primary branched nonionic surfactant is a 2-ethyl hexanol alkoxylate, wherein R₁ is ethyl, R₂ is butyl, x is from 3 to 6 and y is from 6 to 10.

In an embodiment, the composition comprises a first primary branched nonionic surfactant (NS-1) and a second primary branched nonionic surfactant (NS-2). In an embodiment, the ratio of the first primary branched nonionic surfactant to the second primary branched nonionic surfactant is from 4:1 to 1:4, for example 1:1. In an embodiment, the first primary branched nonionic surfactant (NS-1) is of Formula I wherein x is from 3 to 6 and y is from 6 to 10, R₁ is ethyl, and R₂ is butyl. In an embodiment the second primary branched nonionic surfactant (NS-2) is of Formula I wherein x is from 3 to 6, y is from 6 to 10, R₁ is ethyl, and R₂ is butyl, wherein x or y is different from that of x or y in NS-1.

### Secondary Alcohol Ethoxylate

The composition of the present disclosure also includes a secondary alcohol ethoxylate of Formula (II):

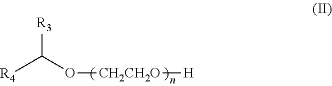

wherein R₃ and R₄ are linear alkyl groups each having from 1 to 12 carbon atoms, and n is an integer from 1 to 20. In an embodiment, R₃ and R₄ are linear alkyl groups each having from 5 to 7 carbon atoms.

In an embodiment, the secondary alcohol ethoxylate is an alkylene oxypolyethylenoxyethanol wherein the alkylene has ten to fifteen (C₁₀₋₁₆) carbon atoms and the number of repeating ethoxylate groups is from 1 to 20. In an embodiment, the number of repeating ethoxylate units is 15.

In the composition, the ratio of the primary branched nonionic surfactant to the secondary alcohol ethoxylate may be from 2:1 to 1:20, for example from 2:1 to 1:10, for example from 2:1 to 1:4.

The composition when blended without the addition of less than 10% water may be provided to the end user as a solid or semi-solid blend.

### Solution

The disclosure further provides an aqueous surfactant solution comprising the surfactant composition, water and optional additives. The solutions of the present disclosure are made by methods known to one skilled in the art. Typically, the nonionic surfactant and secondary alcohol ethoxylate are mixed in the presence of water to form the solution.

The surfactant composition may be manufactured and sold as a solution concentrate. A typical concentrate is delivered to the end user who then dilutes the concentrate with water to produce a final working solution. The surfactant solution may be manufactured and sold as a stable liquid concentrate comprising 60 to 90 wt % of the composition in water.

### Additives

A typical concentrate is delivered to the end user who then further dilutes the concentrate with water and adds other actives to produce a final working solution. The solution of the present disclosure may include additives such as a fragrance compound, alkaline agents such as sodium hydroxide, sodium bicarbonate, silicates, chelants, amines, antioxidants, pigments, salts, dispersants, water soluble polymers, and enzymes.

Additives can be incorporated into the composition in amounts known to those skilled in the art for their intended purpose.

### Applications

In addition to hard surface cleaning, the disclosed composition and solution may be used in a wide variety of applications, including but not limited to, air care products, textile processing, oil and gas, agricultural formulations, coatings, adhesives, emulsion polymerization, plastic additives, emulsifiers, and coupling agents where compatibility and temperature stability is required for the application.

The solutions of the present disclosure provide compatibility with fragrance compounds while maintaining a unique shelf stability at or greater than 60° C., which is not typical of standard surfactants in the industry.

### SPECIFIC EMBODIMENTS

The surfactant concentrates, as represented by the compositions described above, are stable blends that upon dilution with other industry accepted additives including water, solvent, chelants, and perfumes, provide improved cleaning performance that is characterized by excellent filming and streaking comparable to alkyl polyglucoside-based formulations while providing significantly better degreasing performance than alkyl polyglucoside-based formulations. The present composition of surfactants also provides an unexpected and significant improvement in degreasing capability relative to any of the single components or subsets of the disclosed compositions. Although degreasing is a general attribute that is typical of high performance nonionic surfactants, one expects performance variation that is dependent on the specific hydrophobes selected and alkoxylation patterns utilized. Although each component of this composition was optimized on an individual basis, the new compositions show a significant synergistic improvement in cleaning as characterized by an improved degreasing ability and decrease in visual residue that may be left on the surface. This unexpected synergy in cleaning performance is clearly demonstrated in the data provided which shows compositions that provide the unexpected synergy, are similar to an individual component, or fail any of several performance criteria.

### Testing Methods

### Stability Testing

Approximately 5 milliliters (ml) of the cleaning formulation was placed in each of three small glass vials which were capped. Three vials were prepared per composition to allow for testing at different temperatures. One vial was placed in an oven at 60° C. for a minimum of 3 hours, one vial was cooled at 20° C. for a minimum of 3 hours, and one vial was placed in a freezer at 5° C. for 16 hours in the freezer followed by 8 hours at room temperature for 3 days. The solutions were then brought back to room temperature naturally and given one to two shakes. A sample was deemed stable if the formulation maintained a homogeneous appearance and no visible layering at all three temperatures essentially forever (i.e., the solution was not deemed stable if at any time the solution formed layering or gels).

At each temperature, a sample was analyzed to determine whether it was clear, hazy or cloudy. A piece of paper with black text was placed behind the vial at issue. If the black text was clear through the solution, then the solution was deemed clear. If the text could not be seen at all, the solution was deemed cloudy. If the writing could be seen but was not vibrant black, the solution was deemed hazy.

### Filming and Streaking Testing

Filming and streaking tests were performed on glass tiles to test the residue left by the cleaning formulation. Ten drops in a circular pattern were applied to a glass tile and wiped with a folded piece of clean cheese cloth with five passes. No downward pressure was applied on the tile, only pressure to create a back and forth motion. The tiles were left to dry for thirty minutes. The tiles were rated on a scale of 1-10 for both filming and streaking compared to standards. A standard using Windex™ was used as a rating of 1 for both filming and streaking. A standard of Fantastik™ was used as a standard rating of 10 for both filming and streaking. The rating of the samples was performed by visual inspection by the same operator each time.

### Hard Surface Cleaning

The hard surface cleaning power of the cleaning formulations were tested by the removal of soil from a vinyl tile. Vinyl tiles were cut to match the sample size of 11.5 centimeter (cm) by 7.5 cm. 500 microliters (μl) of 3% carbon black brazil soil was applied to the grooved side of the tile using a foam applicator. The tiles were set to dry for approximately twenty-four hours. The tiles were then placed in a Spring Compression Device (SCiD) with 24 independent test wells and set on the orbital shaker. 400 microliters of the cleaning formulations were dispensed into each well along with one carpeted scrubbie and the samples were run on the shaker for five minutes. For each sample, three wells were tested and the results were averaged. The samples were scanned into the computer and analyzed by the ImageJ software manufactured by The Dow Chemical Company. The cleaning power of the formulations was measured by the average of the gray value of the three wells. A higher gray value corresponds to a lighter circle and a higher cleaning power. A lower gray value corresponds to a darker circle and a lower cleaning power.

### Cloud Point Determination

The cloud point is the temperature at which a previously clear, single-phase substance becomes cloudy owning to the appearance of a second phase. The cloudiness lowers the transmittance. The cloud point was determined by ASTM D 2024 using the Mettler FP90 Cloud Point System.

### Viscosity

Viscosity was measured according to ASTM D 445, the standard test method of kinematic viscosity of transparent and opaque liquids, and ASTD D 7042, the standard test method for dynamic viscosity and density of liquids by Stabinger Viscometer.

### Pour Point

Pour points refer to the lowest temperature at which a liquid will flow. The pour point was measured using a MPP 5Gs Pour Point Instrument.

### Contact Angle Testing

The contact angle was measured using the KRUSS DSA-100.

### Equilibrium Surface Tension & Critical Miscellization Concentration (CMC)

CMC is defined as the concentration of surfactants above which micelles are spontaneously formed. Surfactants work best at concentrations above their CMC value. The CMC measured by a Kruss Model 100 Surface Tensiometer.

Two compositions were prepared as Blends 1 and 2. NS-1 is a nonionic surfactant of Formula I wherein R₁ is ethyl, R₂ is butyl, x is 5 and y is 6. NS-2 is a nonionic surfactant of Formula I wherein R₁ is ethyl, R₂ is butyl, x is 5, and y is 9. SAE is a secondary alcohol ethoxylate of Formula II wherein R₃ is pentyl and R₄ is heptyl. As shown in Table 1, Blend 1 comprises 33.33% NS-1, 33.33% NS-2 and 33.33% SAE. Blend 2 comprises 25.0% NS-1, 25.0% NS-2 and 50.0% SAE.

The blends were prepared by adding NS-1 and NS-2 to the SAE at 40° C. Deionized water was added to the warm surfactant blend as described in Table 2 and the solutions were cooled to ambient temperature and stored.

TABLE 1
Percent Compositions of Blends 1 and 2

| | NS-1 | NS-2 | SAE |
|---|---|---|---|
| Blend 1 | 33.33% | 33.33% | 33.33% |
| Blend 2 | 25.0% | 25.0% | 50.0% |

Table 2 presents the viscosity and pour point data for Blends 1 and 2 in various concentrations.

TABLE 2
Viscosity and Pour Point Data

| | Viscosity @ 25 C. | Pour Point |
|---|---|---|
| Sample | (cSt) | (° C.) |
| 100% Blend 1 | Unable to Measure | 15.0 |
| 90% Blend 1 & 10% Water | 135.32 | −9.0 |
| 80% Blend 1 & 20% Water | 189.12 | −30.0 |
| 70% Blend 1 & 30% Water | Not Stable* | −36.0 |
| 60% Blend 1 & 40% Water | 389.94 | 15.0 |
| 50% Blend 1 & 50% Water | Gel | 39.0 |
| 40% Blend 1 & 60% Water | 224.65 | −15.0 |
| 30% Blend 1 & 70% Water | 36.27 | −15.0 |
| 20% Blend 1 & 80% Water | 6.50 | −15.0 |
| 10% Blend 1 & 90% Water | 1.93 | −18.0 |
| 100% Blend 2 | Unable to Measure | 21.0 |
| 90% Blend 2 & 10% Water | 142.29 | 0.0 |
| 80% Blend 2 & 20% Water | 195.52 | −21.0 |
| 70% Blend 2 & 30% Water | 295.15 | −39.0 |
| 60% Blend 2 & 40% Water | Gel | 30.0 |
| 50% Blend 2 & 50% Water | Gel | 48.0 |
| 40% Blend 2 & 60% Water | 240.41 | −18.0 |
| 30% Blend 2 & 70% Water | 38.95 | −15.0 |
| 20% Blend 2 & 80% Water | 6.91 | −15.0 |
| 10% Blend 2 & 90% Water | 1.96 | −12.0 |

*Not stable indicates the instrument would not stabilize due to entrained air bubbles.

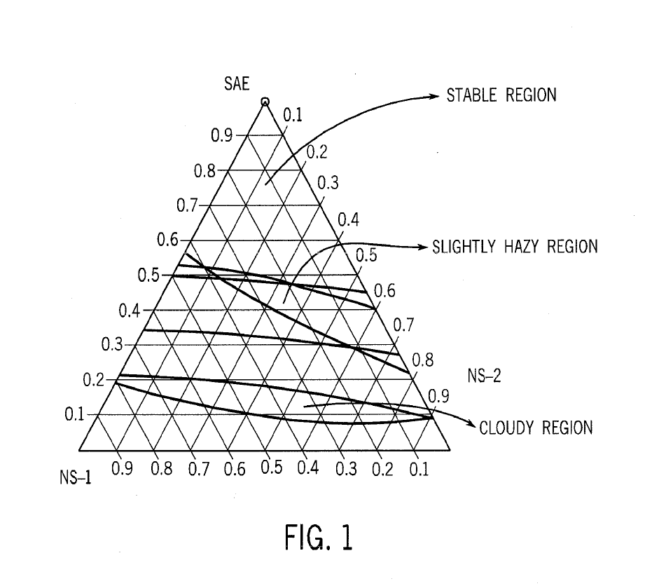

FIG. 1 is a ternary diagram indicating the optimal weight percents of SAE, NS-1 and NS-2 to result in a stable composition.

Table 3 demonstrates cloud point data, critical miscelle concentration data, contact angle data, and equilibrium surface tension data for Blends 1 and 2 compared to compositions of NS-1, NS-2 and SAE alone.

TABLE 3
Cloud Point, Critical Miscelle Concentration, Contact Angle,
and Equilibrium Surface Tension Data

| | | | | Contact | |
|---|---|---|---|---|---|
| | Cloud | | Contact Angle | Angle | Surface |
| | Point | CMC | on Teflon | on Parafilm | Tension |
| | (° C.) | (ppm) | (degrees) | (degrees) | (dynes/cm) |
| Blend 1 | 70.2 | 568 | 67.9 | 58.6 | 31 |
| Blend 2 | 78.9 | 428 | 64.2 | 51.2 | 31 |
| NS-1 | 40.0 | 914 | 68.1 | 58.9 | 30 |
| NS-2 | 61.0 | 1066 | 83.2 | 63.9 | 31 |
| SAE | >100 | 126 | 84.4 | 70.0 | 36 |

The cloud point is the temperature above which a 1 wt % aqueous solution of a water-soluble nonionic surfactant becomes turbid. Blend 2 has a lower contact angle than solutions comprising only NS-1, NS-2 or SAE, which indicates a better ability to wet a surface.

Table 4 demonstrates performance data for various compositions. The solutions were prepared by the weight percents indicated in Table 4 such that the final solutions were 100 g. HEIDA is N-(2-hydroxyethylliminodiacetic acid), disodium salt, 28% active available from The Dow Chemical Company. DiPA is diisopropanol amine available from The Dow Chemical Company. DOWANOL DPnP is dipropylene glycol n-propyl ether commercially available from The Dow Chemical Company.

Samples 1-20 in Table 4 all demonstrated a “clear” solution at 20° C. The pH of samples 1-20 was 12.

TABLE 4
Formulation and Performance Data

| | HEIDA | DPnP | DiPA | SAE | NS-1 | NS-2 | NaOH | Water | Filming | Streaking | SCiD | 60 C. | 5 C. |
|---|---|---|---|---|---|---|---|---|---|---|---|---|---|
| 1 | 0.50% | 1.00% | 0.50% | 0.80% | — | 0.20% | 0.20% | 96.80% | 6 | 7 | 74.82723 | Clear | Clear |
| 2 | 0.50% | 1.00% | 0.50% | 0.80% | 0.10% | 0.10% | 0.20% | 96.80% | 6 | 8 | 85.24714 | Clear | Clear |
| 3 | 0.50% | 1.00% | 0.50% | 0.60% | 0.40% | — | 0.20% | 96.80% | 7 | 8 | 88.21025 | Clear | Clear |
| 4 | 0.50% | 1.00% | 0.50% | 0.60% | 0.20% | 0.20% | 0.20% | 96.80% | 6 | 8 | 73.0516 | Clear | Clear |
| 5 | 0.50% | 1.00% | 0.50% | 0.50% | 0.10% | 0.40% | 0.20% | 96.80% | 7 | 8 | 58.51548 | Clear | Clear |
| 6 | 0.50% | 1.00% | 0.50% | 0.40% | 0.60% | — | 0.20% | 96.80% | 7 | 9 | 75.48935 | Clear | Clear |
| 7 | 0.50% | 1.00% | 0.50% | — | 0.40% | 0.20% | 0.20% | 96.80% | 5 | 7 | 109.664 | Cloudy | Clear |
| 8 | 0.50% | 1.00% | 0.50% | 0.33% | — | 0.66% | 0.20% | 96.80% | 7 | 9 | 77.33183 | Clear | Clear |
| 9 | 0.50% | 1.00% | 0.50% | 0.20% | 0.80% | — | 0.20% | 96.80% | 6 | 9 | 115.5952 | Cloudy | Clear |
| 10 | 0.50% | 1.00% | 0.50% | 0.10% | 0.45% | 0.45% | 0.20% | 96.80% | 6 | 9 | 104.6024 | Cloudy | Clear |
| 11 | 1.00% | 2.00% | 1.00% | 0.80% | — | 0.20% | 0.20% | 94.80% | 5 | 7 | 66.85256 | Clear | Clear |
| 12 | 1.00% | 2.00% | 1.00% | 0.80% | 0.10% | 0.10% | 0.20% | 94.80% | 5 | 7 | 66.5723 | Clear | Clear |
| 13 | 1.00% | 2.00% | 1.00% | 0.60% | 0.40% | — | 0.20% | 94.80% | 6 | 8 | 75.14685 | Clear | Clear |
| 14 | 1.00% | 2.00% | 1.00% | 0.60% | 0.20% | 0.20% | 0.20% | 94.80% | 6 | 8 | 72.74891 | Clear | Clear |
| 15 | 1.00% | 2.00% | 1.00% | 0.50% | 0.10% | 0.40% | 0.20% | 94.80% | 6 | 8 | 77.25292 | Clear | Clear |
| 16 | 1.00% | 2.00% | 1.00% | 0.40% | 0.60% | — | 0.20% | 94.80% | 7 | 9 | 85.21827 | Cloudy | Clear |
| 17 | 1.00% | 2.00% | 1.00% | — | 0.40% | 0.20% | 0.20% | 94.80% | 8 | 9 | 104.4742 | Cloudy | Clear |
| 18 | 1.00% | 2.00% | 1.00% | 0.33% | — | 0.66% | 0.20% | 94.80% | 7 | 8 | 82.03111 | Clear | Clear |
| 19 | 1.00% | 2.00% | 1.00% | 0.20% | 0.80% | — | 0.20% | 94.80% | 8 | 9 | 116.6918 | Cloudy | Clear |
| 20 | 1.00% | 2.00% | 1.00% | 0.10% | 0.45% | 0.45% | 0.20% | 94.80% | 8 | 8 | 117.0801 | Cloudy | Clear |

Table 5 presents compositions coupled with a fragrance compound in the presence of secondary alcohol ethoxylate compared to primary alcohol ethoxylates. Both linear and branched primary alcohol ethoxylates Neodol 25-7, Neodol 45-7 (available from Shell Chemicals), Lutensol XP60, and Lutensol XP-70 (available from BASF) failed to effectively couple fragrance materials whereas the secondary alcohol ethoxylates were effective at coupling fragrance materials, as indicated by the stable compositions over a range of temperatures.

The compositions in Table 5 all comprise 1 wt % HEIDA, 0.50 wt % DiPA, 0.20 wt % NaOH, 2.0 wt % DPnP, and 0.5% Outdoor fragrance (available from Firmenich). Table 6 presents the percent compositions of Surfactants A-F in Table 5. Filming and streaking performance was not measured if the solution was not clear at 20° C.

TABLE 5
Performance Data

| Surfactant | Amount | Water | Filming | Streaking | Avg Grey Values | 20° C. | 60° C. | 5° C. |
|---|---|---|---|---|---|---|---|---|
| A | 1.00% | 95.30% | 5 | 5 | 78.44 | Clear | Clear | Clear |
| A | 2.00% | 94.30% | 7 | 8 | 88.45 | Clear | Clear | Clear |
| B | 1.00% | 95.30% | 6 | 6 | 128.94 | Clear | Cloudy | Clear |
| B | 2.00% | 94.30% | 8 | 8 | 144.57 | Clear | Cloudy | Clear |
| C | 1.00% | 95.30% | 6 | 5 | 91.58 | Clear | Clear | Clear |
| C | 2.00% | 94.30% | 8 | 9 | 108.56 | Clear | Clear | Clear |
| D | 1.00% | 95.30% | 6 | 7 | 108.19 | Clear | Clear | Clear |
| D | 2.00% | 94.30% | 8 | 9 | 119.55 | Clear | Clear | Clear |
| E | 1.00% | 95.30% | 5 | 5 | 121.42 | Clear | Cloudy | Clear |
| E | 2.00% | 94.30% | 8 | 8 | 140.09 | Clear | Hazy | Clear |
| F | 1.00% | 95.30% | 7 | 7 | 97.31 | Clear | Clear | Clear |
| F | 2.00% | 94.30% | 7 | 8 | 95.58 | Clear | Clear | Clear |
| G | 1.00% | 95.30% | 6 | 8 | 109.72 | Clear | Clear | Clear |
| G | 2.00% | 94.30% | 8 | 10 | 125.38 | Clear | Clear | Clear |
| H | 1.00% | 95.30% | 7 | 7 | 138.76 | Clear | Hazy | Clear |
| H | 2.00% | 94.30% | 8 | 7 | 143.15 | Clear | Hazy | Clear |
| I | 1.00% | 95.30% | 8 | 8 | 134.32 | Clear | Cloudy | Clear |
| I | 2.00% | 94.30% | 8 | 9 | 137.98 | Clear | Cloudy | Clear |
| J | 1.00% | 95.30% | 6 | 8 | 79.19 | Clear | Clear | Clear |
| J | 2.00% | 94.30% | 7 | 7 | 83.32 | Clear | Clear | Clear |
| K | 1.00% | 95.30% | 8 | 8 | 143.48 | Clear | Cloudy | Clear |
| K | 2.00% | 94.30% | 9 | 9 | 146.56 | Clear | Cloudy | Clear |
| L | 1.00% | 95.30% | 7 | 8 | 119.20 | Clear | Clear | Clear |
| L | 2.00% | 94.30% | 8 | 9 | 134.97 | Clear | Clear | Clear |
| Neodol | 1.00% | 95.30% | 8 | 8 | 133.89 | Clear | Cloudy | Clear |
| 25-7 | | | | | | | | |
| Neodol | 2.00% | 94.30% | 9 | 5 | 144.47 | Clear | Cloudy | Hazy |
| 25-7 | | | | | | | | |
| Neodol | 1.00% | 95.30% | 9 | 4 | 100.85 | Clear | Cloudy | Cloudy |
| 45-7 | | | | | | | | |
| Neodol | 2.00% | 94.30% | 9 | 3 | 125.43 | Clear | Cloudy | Cloudy |
| 45-7 | | | | | | | | |
| Lutensol | 1.00% | 95.30% | X | X | 145.95 | Hazy | Cloudy | Hazy |
| XP-60 | | | | | | | | |
| Lutensol | 2.00% | 94.30% | X | X | 142.28 | Hazy | Cloudy | Hazy |
| XP-60 | | | | | | | | |
| Lutensol | 1.00% | 95.30% | X | X | 150.43 | Clear | Cloudy | Clear |
| XP-70 | | | | | | | | |
| Lutensol | 2.00% | 94.30% | X | X | 151.99 | Clear | Cloudy | Clear |
| XP-70 | | | | | | | | |

TABLE 6
Surfactant Compositions used in Table 5

| Surfactant | SAE | NS-1 | NS-2 |
|---|---|---|---|
| A | 67.00% | 17.00% | 17.00% |
| B | 0.00% | 50.00% | 50.00% |
| C | 33.00% | 33.00% | 33.00% |
| D | 50.00% | 50.00% | 0.00% |
| E | 17.00% | 17.00% | 67.00% |
| F | 50.00% | 25.00% | 25.00% |
| G | 50.00% | 0.00% | 50.00% |
| H | 0.00% | 0.00% | 100.00% |
| I | 17.00% | 67.00% | 17.00% |
| J | 100.00% | 0.00% | 0.00% |
| K | 0.00% | 100.00% | 0.00% |
| L | 50.00% | 25.00% | 25.00% |

What is claimed is:

1. A composition comprising:
a) at least one primary branched nonionic surfactant of Formula (I) 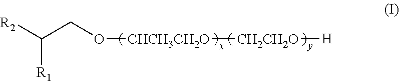
wherein x is an integer from 1 to 11, y is an integer from 0 to 25, R₁ is an alkyl group having 1 to 5 carbon atoms, and R₂ is an alkyl group having 3 to 7 carbon atoms; and
b) a secondary alcohol ethoxylate of Formula (II) 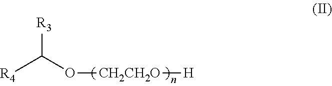
wherein R₃ and R₄ are linear alkyl groups each having from 1 to 12 carbon atoms, and n is an integer from 1 to 20.

2. The composition of claim 1 wherein the composition comprises a ratio of the primary branched nonionic surfactant to the secondary alcohol ethoxylate from 2:1 to 1:10.

3. The composition of claim 1 comprising a primary branched nonionic surfactant wherein x is from 3 to 6, y is from 6 to 10, R₁ is ethyl and R₂ is butyl.

4. The composition of claim 3 further comprising a second primary branched nonionic surfactant wherein x is from 3 to 6, y is from 6 to 10, R₁ is ethyl and R₂ is butyl, wherein the x and y of the second primary branched nonionic surfactant differs from the x or y of the primary branched nonionic surfactant.

5. The composition of claim 1 wherein R₃ and R₄ are linear alkyl groups each having from 5 to 7 carbon atoms.

6. A solution comprising 60 to 90 wt % of the composition of claim 1 in water wherein the solution has a viscosity at 25° C. of less than 500 cP.

7. The solution of claim 6 further comprising a fragrance compound.

8. A hard surface cleaner comprising the composition of claim 1.

9. The hard surface cleaner of claim 8 further comprising a fragrance compound.
